(19) United States
(12) Patent Application Publication
(10) Pub. No.: US 2015/0014219 A1
(43) Pub. Date: Jan. 15, 2015

(54) METHOD AND APPARATUS FOR SEPARATING EVAPORATABLE COMPONENTS FROM A FLUID

(71) Applicant: ECOTECFUEL, LLC, RENO, NV (US)

(72) Inventor: Wolfgang Spiess, Rosstal (DE)

(21) Appl. No.: 14/373,231

(22) PCT Filed: Jan. 18, 2013
(86) PCT No.: PCT/EP2013/050970

§ 371 Date: Jul. 18, 2014

(30) Foreign Application Priority Data
Jan. 20, 2012 (DE) 10 2012 000 985.2

(51) Int. Cl. C10G 7/02; B01D 1/16

(52) U.S. Cl. CPC C10G 7/02; B01D 1/16
USPC 208/359; 196/128

(57) ABSTRACT

A method and an apparatus for separating evaporatable components from a heated fluid (2) are described. The heated fluid (2) is subdivided into two partial fluid streams (2t) of equal size, and the partial fluid streams (2t) are introduced in such a way at an angle of incidence (α) different from zero preferably relative to the horizontal reference plane that the partial fluid streams (2t) collide in such a way as to form a fluid bubble (2b).

The invention relates to a method and a device for separating evaporable components from a fluid.

A process is known from DE 10 2005 056 735 B3 for the production of diesel oil from residues containing hydrocarbons in a mixture circuit by means of the separation of solids and distillation of the diesel product. The mixture in question is an oil, residual fuel and catalyst mixture. The residues used contain long-chain hydrocarbons which are split by means of the catalyst into short-chain hydrocarbons that are suitable as diesel components. The evaporation of the diesel components from the liquid mixture circulating in a circuit and heated to 280 to 320° C. is effected by means of a separator, into which the mixture is sprayed by means of the venturi in order to generate a large evaporation surface. In this way, the mixture comes into contact with the wall of the separator and transfers heat energy that must be subsequently added to the mixture again.

The object of the present invention is to provide an improved method and apparatus to reduce the transfer of heat energy from the heated mixture.

The object is achieved with a method for separating evaporable components from a heated fluid, whereby the heated fluid is divided into two equally large fluid streams, and whereby the fluid streams are preferably so introduced at an angle of incidence different from zero with respect to the horizontal reference plane, that the fluid streams meet one another in such a way as to form a fluid bubble.

The object is further solved by a device for separating evaporable components from a heated fluid, comprising a separator and an atomizer arranged within the separator, whereby the atomizer is in the form of a symmetrical pipe/nozzle that divides the fluid into two equally large fluid streams, and where atomizing nozzles are inclined at an angle different from zero with respect to a reference plane, preferably horizontal, and are spaced apart and opposite to one another.

The proposed method and the proposed device have the advantage that firstly the fluid is concentrated in a space in the fluid bubble so generated, and secondly, the fluid is split into fine droplets, so that a large evaporation surface is produced. The droplets escaping downwards from the fluid bubble due to the force of gravity form a fine mist curtain that falls downwards more slowly than a compact stream of fluid, whereby the volatile components are available for evaporation for a longer time.

Because the fluid bubble is not in contact with the walls, there is no undesired heat transfer from the fluid to the walls.

It may be arranged that the fluid bubble is formed in a separator in such a way that it is not in contact with a wall of the separator.

In an advantageous embodiment, it may be arranged that the fluid streams are inclined at an equal angle of incidence from +30° to +60° or from −60° to −30° with respect to the horizontal reference plane.

It may preferably be arranged that the fluid streams pass through nozzles having a slot-shaped outlet.

It may preferably be arranged that the slot-shaped outlet is arranged horizontally.

It may further be arranged that the slot-shaped outlets are arranged opposite to one another at such a distance and at such an angle that the fluid bubble is formed with a flat elliptical cross-section. The spacing may preferably be determined by experiment. However, it may also be arranged to make the distance adjustable, so that adjustment during operation is possible.

The nozzles may be inclined at a preferably equal angle of incidence from +30° to +60° or from −30° to −60° with respect to the preferably horizontal reference plane.

Further sub-claims concern the device.

As described above, the nozzles may have a slot-shaped outlet.

The slot-shaped outlet may be arranged horizontally.

The slot-shaped outlets may be positioned opposite to one another at such a distance and at such an angle that the fluid bubble is formed with a flat elliptical cross-section.

Such a device intended for the separation of evaporable components from a heated fluid may be so designed through suitable experiments, that the separation process takes place optimally. To increase the bandwidth of the usable residual substances, the device may be modified so that it is adaptable over a wide range.

In the supply lines to the nozzles or in the nozzles themselves, throttle means may be provided to adjust the fluid streams so that the two fluid streams are of equal size. This is in order to compensate for manufacturing tolerances and/or cross-sectional constrictions occurring during operation as a result of a substance build up on the inner walls. Adjustment devices may be provided in order to adjust the distance between the opposing slot-shaped outlets and/or the angle of incidence during operation, so that a fluid bubble is formed with a predetermined cross-section.

In addition, sensors may be provided to detect the geometry of the fluid bubble during operation, and a control device provided to control the adjustment means described above, so that the actual geometry of the fluid bubble corresponds to a desired geometry.

The invention will now be explained in more detail with reference to embodiments. The figures are as follows:

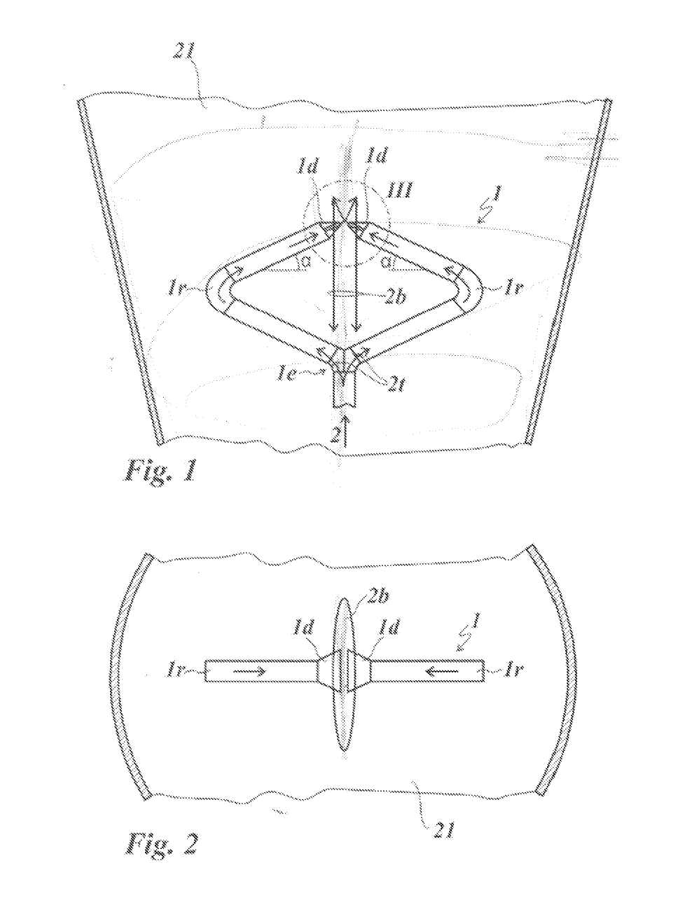

FIG. 1 shows a schematic side view of an embodiment of a device according to the invention for separating evaporable components from a heated fluid;

FIG. 2 shows a schematic plan view of the device in FIG. 1;

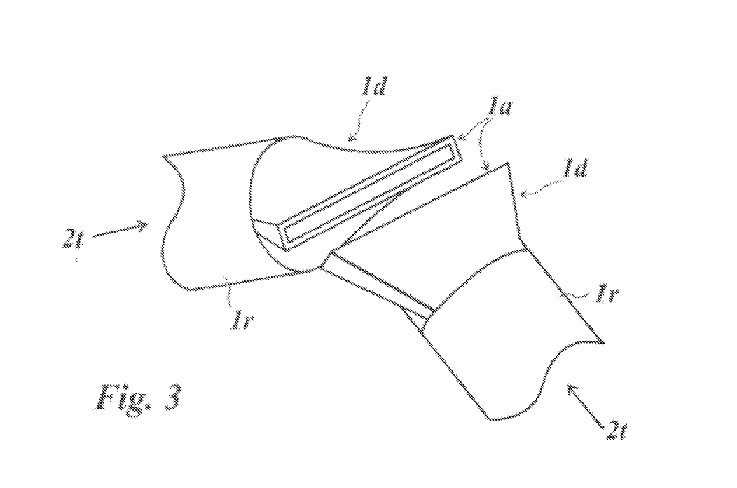

FIG. 3 shows a schematic perspective view of an enlarged section III in FIG. 1;

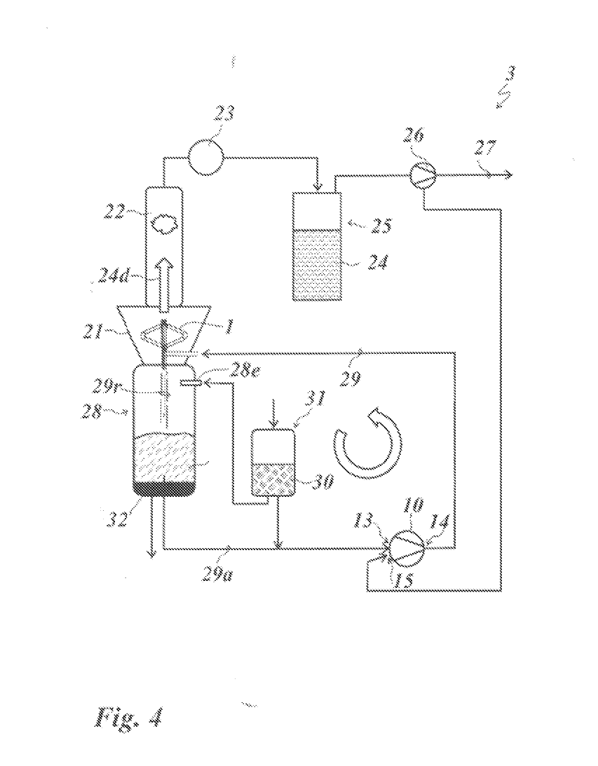

FIG. 4 shows a block diagram of a KDV (catalytic pressure-free depolymerization) plant for the production of diesel oil from hydrocarbon-containing waste substances.

FIGS. 1 to 3 show an embodiment of a device according to the invention for separating evaporable components from a heated fluid 2 The device has an atomizer 1 in the form of a symmetrical pipe/nozzle device to form a fluid bubble 2b with a large surface area, and is arranged in a separator 21. The fluid 2 is an oil, residual substance and catalyst mixture at a temperature in the range of 280 to 320° C. The fluid 2 contains, as described below, evaporable short-chain hydrocarbons, which are separated in the separator 21 to form diesel oil after condensation.

The atomizer 1 comprises a T-shaped inlet section 1e in which a fluid stream 2 to the atomizer 1 is split into two equal fluid streams 2t, which are directed towards one another by means of two V-shaped pipe sections 1r at the end sections of their nozzles 1d. The nozzles 1d are directed at an angle of incidence α inclined upwards to the horizontal. The nozzles 1d have slotted outlets 1a from which emerges the partial fluid flow 2t. The slot-shaped outlets 1a are arranged horizontally in the operative position of the atomizer 1 and are inclined upwards due to the angle of incidence α of the nozzle 1d. However, it may also be arranged that the nozzles may be inclined downwards below the angle of incidence α. The same angle of incidence α for both nozzles 1d is preferably in the range from +30° to +60° and from −30° to −60°.

The distance between the two mutually facing outlets 1a should be so experimentally determined that a fluid bubble 2b is formed with a flat elliptical cross-section that does not touch the inner wall of the separator 21.

In addition to the advantage that the fluid bubble 2b has a large surface area which encourages the evaporation of the diesel oil components contained in the fluid, strong turbulence occurs in the fluid and increases the effectiveness of the catalyst.

In the embodiment shown in FIGS. 1 to 4, the separator 21 is in the form of an upwardly expanding hollow cone-shaped container, whose bottom plate and cover plate have holes leading to a distillation column 22 arranged on the separator 21, and to a central container arranged under the separator 21 (see FIG. 4).

FIG. 4 shows a block diagram of a KDV plant 3 for catalytic pressure-free depolymerization with a device according to the invention intended to separate evaporable components from a heated fluid. In the KDV plant 3, at a process temperature of 280 to 320° C. and under the action of a catalyst, long-chain hydrocarbons are split into short-chain hydrocarbons such as are contained in diesel oil. For this purpose, a fluid substance mixture 29 at the process temperature and in which there is an oil, residual fuel and catalyst mixture, is fed into the circuit by the fluid ring pump 10. The residues consist mainly of long-chain hydrocarbons that are converted to diesel oil 24 in the KDV plant 3. The residues may be in the form of inorganic waste, such as waste oil and plastics or the like, or organic solids, such as sawdust, wood chips or the like.

The thoroughly-mixed foam phase substance mixture 29 is fed into the separator 21 via a pressure pipe 14 of the liquid ring pump 10 and an intermediate pipe by means of the atomizer 1. As described above, the short-chain hydrocarbons are then evaporated into diesel oil vapour 24d. The diesel oil vapour 24d flows into the distillation column 22 arranged above the separator 21, and then enters a condenser 23 arranged downstream of the distillation column 22. The condensate is precipitated In the condenser 23 in the form of diesel oil 24 which is collected in a product tank 25. The reservoir 25 can be vented using a vacuum pump 26, whereby a portion of the exhaust gas 27 accumulated above the diesel oil 24 is fed to a gas nozzle 15 of the liquid ring pump 10. To start the process in place of the exhaust gas, an inert gas such as nitrogen is fed from a compressed gas container.

The evaporated substance mixture 29r flows into the central container 28 arranged under the separator 21. The central container 28 may have an inlet nozzle 28e, via which the hydrocarbon-containing residues 30 may be fed from a residue reservoir 31 into the substance mixture 29r. The residue 30 is dissolved in the evaporated substance mixture 29r and is homogeneously dispersed on the way through the central reservoir 28. However, the residue 30 may also be fed into the mixture circuit downstream behind the central reservoir 28. The enriched mixture 29a emerging from the central reservoir 28 is supplied to a suction nozzle 13 of the liquid ring pump 10, to close the substance mixture circuit.

Deposited sediment particles 32 may be removed from the substance mixture 29a at the bottom of the central container 28 in order to be used as fuel or discarded.

### LIST OF REFERENCE NUMERALS

1 atomizer
1a outlet
1d nozzle
1e inlet section
1f pipe
2 fluid stream
2b fluid bubble
2t fluid partial stream
3 KDV plant
10 fluid ring pump
13 suction nozzle
14 pressure nozzle
15 gas nozzle
21 separator
22 distillation column
23 condenser
24 diesel oil
24d diesel oil vapour
25 product tank
26 vacuum pump
27 exhaust gas
28 central container
28e innet nozzle
29 substance mixture
29a enriched mixture
29r evaporated mixture
30 residue
31 residue reservoir
32 sediment particles

1. A method for separating evaporable components from a heated fluid,
wherein
the heated fluid is divided into two equally large partial streams of fluid, and
the fluid streams are introduced at an angle of incidence different from zero with respect to a preferably horizontal reference plane so that the fluid streams come together in such a way as to form a fluid bubble.

2. A method according to claim 1,
wherein
the fluid streams are inclined at an equal angle of incidence from +30° to +60° and from −30° to −60° with respect to the horizontal reference plane.

3. A method according to claim 1,
wherein
the fluid streams are fed through nozzles with a slot-shaped outlet.

4. A method according to claim 3,
wherein
the slot-shaped outlet is arranged horizontally.

5. A method according to claim 3,
wherein
the slot-shaped outlets are arranged opposite one another at such a distance and at such an angle that the fluid bubble is formed with a flat elliptical cross-section.

6. A method according to claim 1, whereby the separation is performed in a flow chamber of a separator device,
wherein
the fluid bubble is formed in a separator so that it is not in contact with a wall of the separator.

7. A device for separating evaporable components from a heated fluid, comprising a separator and an atomizer arranged in the separator,
wherein
the atomizer (1) is in the form of a symmetrical pipe/nozzle device that separates the fluid into two equal partial fluid streams, and
the atomizer is at an angle different from zero to the nozzles inclined to the horizontal plane, whereby the nozzles are arranged spaced apart and opposite to one another.

8. A device according to claim 7,
wherein
the nozzles (1d) are inclined at an equal angle of incidence from +30° to +60°, or from −30° to −60° relative to the horizontal.

9. A device according to claim 7,
wherein
the nozzles have a slot-shaped outlet.

10. A device according to claim 9,
wherein
the slot-shaped outlet is arranged in a preferably horizontal reference plane.

11. A device according to claim 9,
wherein
the slot-shaped outlets are arranged opposite one another at such a distance and at such an angle that the fluid bubble is formed with a flat elliptical cross section.
